(19) United States
(12) Patent Application Publication
(10) Pub. No.: US 2005/0027624 A1
(43) Pub. Date: Feb. 3, 2005

(54) Supplementary prepaid account for postpaid service subscribers

(76) Inventor: Yigang Cai, Naperville, IL (US)

Correspondence Address: Lucent Technologies Inc.;Docket Administrator (Room 3J-219), 101 Crawfords Corner Road, Holmdel, NJ, 07733-3030, US

(21) Appl. No.: 10/628,716

(22) Filed: Jul. 28, 2003

(51) Int. Cl. G06F 17/60

(52) U.S. Cl. 705/32; 705/34

(57) ABSTRACT

An intelligent network-based communication system 100 contains one or more service control points (SCPs) 102 for maintaining co-existing prepaid and postpaid accounts for a plurality of subscribers. The prepaid accounts are supplementary to the postpaid accounts for billing purposes. Subscriber activity is monitored in relation to postpaid plan free bucket thresholds and, on occasion(s) where postpaid threshold(s) would be surpassed, billing is diverted from the postpaid account to the prepaid account to achieve lower rates.

### FIELD OF THE INVENTION

This invention relates generally to communication systems billing plans and, more particularly, to providing contingency billing of postpaid subscribers to a supplementary account.

### BACKGROUND OF THE INVENTION

Calls placed over wireless telecommunications facilities are commonly billed as “postpaid” transactions (i.e., on a periodic basis after occurrences of calls) based on accumulated airtime minutes in relation to a service plan. Typically, under such plans, the subscriber is charged a base fee in return for certain “free” airtime minutes, sometimes referred to as a “free bucket,” during a period of time (usually monthly). For example, Sprint PCS offers a plan of 3500 minutes monthly, including 300 “any time minutes” and 3200 night and weekend minutes. Usually, the service provider charges a per-minute rate for airtime minutes exceeding the plan (e.g., 40 cents per minute for exceeded any time minutes). Most subscribers do not wish to pay this higher rate, so they monitor and control their wireless phone usage (most particularly, their anytime minutes) to stay within the specified plan limits. This situation is burdensome to subscribers and ultimately inhibits wireless phone usage and lowers service provider revenue due to unrealized billing opportunities.

Generally, this problem is not unique to wireless service providers but is applicable to virtually any plan-based postpaid billing arrangement, now or in the future, that charges higher rates for subscriber activity exceeding a postpaid plan free bucket threshold (hereinafter “surplus activity”). As one example, an Internet service provider might a monthly subscription fee for content comprising, for example, news, e-mail, sports information, stock quotes, weather updates, etc. not exceeding a certain threshold amount (e.g., based on the number of minutes, messages, packets or other suitable metric) but a higher rate for content exceeding the threshold. Similar to the case of wireless service providers, this situation results (or will result) in subscribers monitoring and controlling their Internet usage to avoid surplus activity, thereby inhibiting Internet usage and lowering service provider revenue.

Accordingly, a need exists for a method for service providers to monitor subscriber activity (e.g., airtime usage, Internet usage) relative to a postpaid plan, thus relieving subscribers from such burden, and to divert charges to a supplementary account on occurrence of surplus activity so as to enable the subscriber to avoid the relatively high charges of the postpaid account for such surplus activity. Advantageously, the supplementary account comprises a prepaid account having a charge rate lower than the corresponding postpaid rate for surplus activity so as to reduce customer worries relating to excess minutes, promote additional subscriber activity and hence increase service provider revenue.

### SUMMARY OF THE INVENTION

The present invention provides for establishing a supplementary account (e.g., prepaid account) for wireless postpaid subscribers. The supplementary account is used for billing purposes on occasion(s) of “surplus activity” (defined as subscriber activity exceeding postpaid plan “free bucket” thresholds), thereby avoiding higher charges that would occur by billing surplus activity according to the postpaid plan. In such manner, for example, subscriber activity exceeding “anytime minutes” or “free minutes bucket” of a plan threshold may be automatically charged to the prepaid account at a lower rate than would occur under the postpaid plan.

In one embodiment, there is provided a method for use in a communication system providing a service to a postpaid plan subscriber having a postpaid account. The method provides for monitoring subscriber activity relative to one or more postpaid plan thresholds, subscriber activity defining an amount of service provided to the subscriber within a billing period associated with the postpaid account. For so long as the subscriber activity does not exceed a postpaid plan threshold, the subscriber is billed according to the postpaid account. But if the subscriber activity exceeds a postpaid plan threshold, defining surplus activity, at least a portion of the surplus activity is billed to a supplementary account.

In another embodiment, a prepaid account is established for contingency billing of a postpaid plan subscriber. A record is maintained including indicia of activity of the postpaid plan subscriber relative to one or more postpaid plan thresholds. The prepaid account is billed in response to activity of the postpaid plan subscriber exceeding any of the one or more postpaid plan thresholds.

### BRIEF DESCRIPTION OF THE DRAWINGS

The foregoing and other advantages of the invention will become apparent upon reading the following detailed description and upon reference to the drawings in which:

FIG. 1 is a block diagram of an intelligent network-based communication system according to an embodiment of the present invention;

FIG. 2 is a flowchart of a method for setting up a supplementary prepaid account associated with a postpaid account according to an embodiment of the present invention; and

FIG. 3 is a flowchart of a method for charging postpaid subscriber activity to a supplementary prepaid account according to an embodiment of the present invention.

### DESCRIPTION OF THE PREFERRED EMBODIMENT(S)

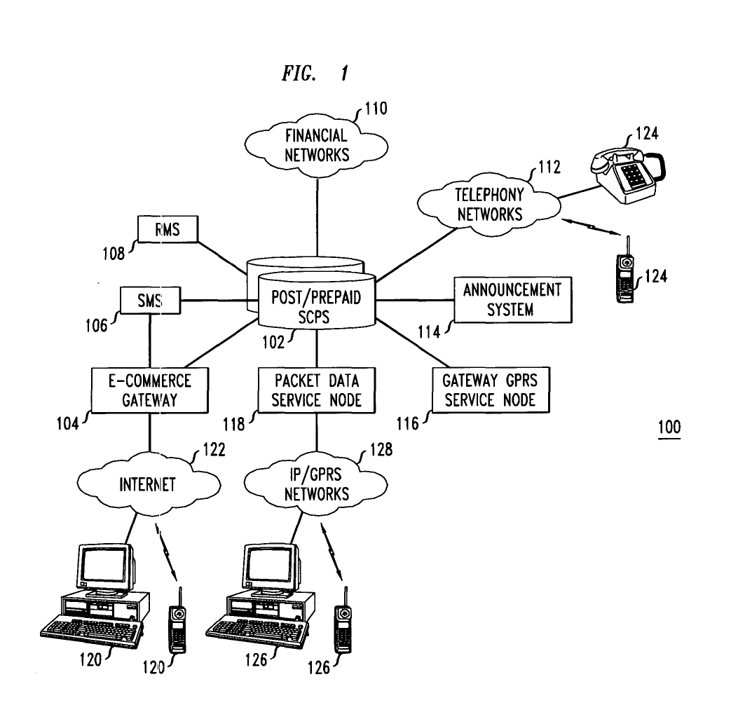

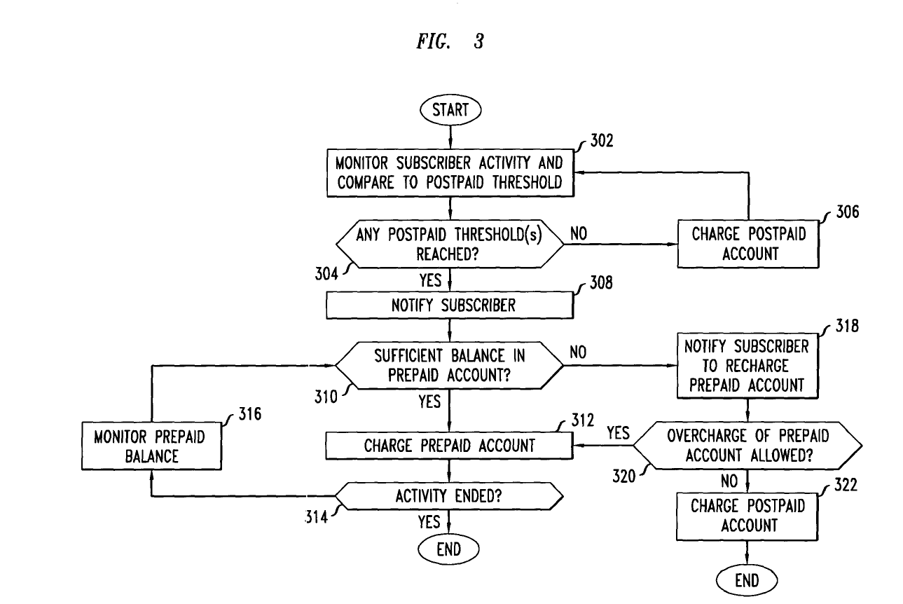

Turning now to the drawings and referring initially to FIG. 1, there is shown an intelligent network-based communication system 100 according to one embodiment of the present invention. The communication system 100 includes one or more SCPs 102 for maintaining subscriber accounts and to manage service provider access and billing of the accounts. In the preferred embodiment, the SCPs 102 maintain co-existing postpaid and prepaid accounts for one or more subscribers, whereby charges are nominally billed to the postpaid account and the prepaid account is used for contingency billing in instances where postpaid plan limits are (or would be) exceeded. To that end, the SCPs include processors and memory (not shown) for establishing supplementary prepaid accounts (FIG. 3) and charging to the prepaid account(s) when postpaid activity exceeds predefined limits of the postpaid account (FIG. 4). As will be appreciated, the SCPs are functional elements that may be realized by one or more physical devices. In one embodiment, the SCPs comprise a mated pair (i.e., a designated “primary” and “secondary” SCP); however, other implementations are possible.

In one embodiment, the SCPs 102 are connected to an e-commerce gateway 104, service management system (SMS) 106, recharge management system (RMS) 108, financial networks 110, wireless/wireline networks 112, announcement system 114, gateway GPRS service node (GGSN) 116 and packet data service node 118.

The e-commerce gateway 104 serves as an interface for e-commerce service providers and/or subscribers (“end users”) 120 to access the SCPs 102 and hence, to access postpaid and/or prepaid subscriber accounts. The end users 120 (as shown, a personal computer and wireless radio/telephone) access the e-commerce gateway 104 via the Internet 122. As will be appreciated, alternative configurations are possible, including but not limited to different end user devices or end user devices that interface directly to the e-commerce gateway 104 (i.e., via links/networks other than the Internet 122).

The SMS 106 performs provisioning, administration and management functions for the postpaid and prepaid accounts. Generally, this includes generating and/or maintaining subscriber and service information associated with the postpaid and prepaid accounts and downloading the information as required to the SCPs 122. For example, duties of the SMS 106 may include: establishing new subscriber accounts and/or maintaining existing accounts (including subscriber IDs, credit amounts); mapping subscriber IDs to primary/secondary SCPs; identifying various attributes of the subscribers (for example, age, sex, language type, currency type, usage data, service preferences and/or restrictions); and generating comprehensive reports of account/usage information.

The RMS 108 facilitates periodic recharging or replenishing of the prepaid accounts and communicating the recharging information as required to the SMS 106.

The financial networks 110 interface to the SCPs 102 for purposes including recharge of a prepaid account (e.g., recharge via credit card or ATM debit card) or to effect payment to service providers or merchants for subscriber transactions.

The telephony networks 112 comprise wired or wireline networks and associated switches (comprising, for example, 5ESS® switching systems, available from Lucent Technologies, Inc.) to support end users 124 using wireline and/or wireless phones.

The announcement system 114 comprises an intelligent peripheral device for selecting and playing pre-recorded announcements, as appropriate, to end users or service providers. For example, as will be described in greater detail in relation to FIG. 3, announcements may be provided to notify subscribers when their airtime charges are being diverted from a postpaid to a prepaid account.

The gateway GPRS service node (GGSN) 116 and packet data service node 118, respectively, interface General Packet Radio Service (GPRS) and high-speed data subscribers 126 to the SCPs 102 via IP/GPRS networks 128. In one embodiment, duties of the service nodes 116, 118 include generating subscriber account/usage information (e.g., number of minutes, messages, packets, etc.) and downloading the information as required to the SCPs 102.

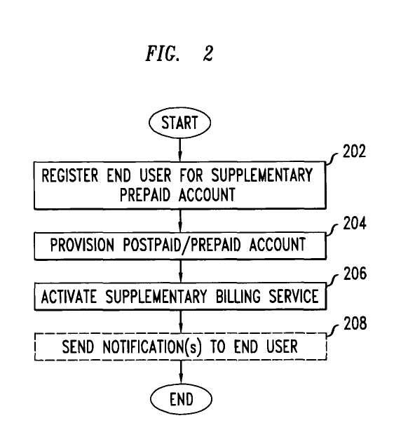

Turning to FIG. 2, there is shown a flowchart illustrating steps in setting up a supplementary prepaid account associated with a postpaid account according to one embodiment of the present invention. The steps of FIG. 2 are implemented, where applicable, by a service provider utilizing the service management system (SMS) 106 in conjunction with the SCPs 102.

At step 202, the service provider registers an end user for a supplementary prepaid account. The end user may comprise, for example, an e-commerce customer 120, wireless or wireline postpaid telephone subscriber 124 or high-speed data subscriber 126 having a postpaid account that charges relatively high rates for service exceeding a particular threshold, who wishes to establish contingency billing to the supplementary account to avoid exceeding the postpaid threshold. It is contemplated that the user will identify the postpaid account when registering for the prepaid account. The end user may purchase the supplementary prepaid account through the Internet 122, customer care service (associated with SMS 106), telephony networks 112 or IP/GPRS networks 128. The prepaid account may be funded by credit card, debit card, or even post billing (in the latter case, the account is presumed to be paid in advance of activation of the account). Alternatively or additionally, a supplementary account other than a prepaid account may be established for contingency billing.

At step 204, the service provider provisions postpaid/prepaid accounts with parameters necessary to implement the supplementary billing service. For example, the service provider may “flag” a particular postpaid account indicating there is an associated prepaid account to be charged for subscriber activity exceeding postpaid plan limits, provision for particular postpaid plan thresholds (e.g., 300 any time minutes allowed before billing to prepaid account) or establish charge rates, life cycle/expiration time of the supplementary billing service, and so forth.

At step 206, the service provider activates the supplementary billing service, hence enabling the subscriber to perform postpaid subscriber activity (e.g., airtime usage, Internet usage) with charges exceeding the postpaid plan automatically charged to the subscriber's supplementary prepaid account. In one embodiment, activation of the supplementary billing service is accomplished in conjunction with activation of the supplementary prepaid account upon receiving personal information (e.g., subscriber name, drivers license, cell phone number) and prepaid account information (e.g., prepaid card serial number and/or PIN). Operation of the supplemental billing service will be described in greater detail in relation to FIG. 3.

Optionally, at step 208, the service provider may notify the user that the supplementary billing service is successfully activated. The notification may further include information such as prepaid account balance, recharge date, maximum or minimum recharge amount and the like.

FIG. 3 is a flowchart of an alternative billing service according to one embodiment of the invention, whereby subscriber activity nominally charged to a postpaid account is charged to a prepaid account upon reaching postpaid thresholds. The subscriber activity may comprise wireless phone usage, internet usage or generally any activity that is nominally charged to a postpaid account under a plan that defines certain thresholds, and wherein a different rate is triggered upon exceeding threshold(s). The activity may be measured (and the threshold(s) defined) by accumulated numbers of minutes, messages, packets or any other suitable metric. The steps of FIG. 3 are implemented, where applicable, by using stored software routines within one or more SCPs 102 of the communication system 100.

At step 302, the SCPs 102 monitor subscriber activity and compare to postpaid thresholds. In one embodiment, the SCPs maintain a record mapping a plurality of individual subscribers to accumulated activity and postpaid thresholds to assist in performing the steps of FIG. 3. For example, in the case of wireless phone usage, the SCP may maintain a record indicating thresholds according to subscriber John Jones postpaid plan as comprising 3500 minutes monthly, 300 any time minutes and 3200 night and weekend minutes, and that he has accumulated 290 any time minutes and 2000 night and weekend minutes so far this month. In the preferred embodiment, the record is maintained substantially in real-time, such that minutes and billing are incremented during subscriber activity (e.g., during live calls). It is noted, in the case of postpaid wireless phone usage, service providers do not presently track billing amounts in real time.

At step 304, the SCP determines whether subscriber activity has caused any of the postpaid thresholds to be reached. In the preferred embodiment, this determination is made in real-time. Thus, continuing the above example, subscriber Jones' any time minutes threshold of 300 will be reached after 10 more any time minutes. In such case, if subscriber Jones initiates a call during “any time” hours that exceeds 10 minutes, the SCP will make a positive determination at step 304 (i.e., determine that a postpaid threshold has been reached) at the 10-minute point of the call. Otherwise, until such time that the call reaches the 10-minute point (or if the call ends before the 10-minute point), the SCP will make a negative determination at step 304. In response to a negative determination at step 304, the SCP accrues subscriber activity charges to the postpaid account at step 306 and the process returns to step 302 to continue monitoring subscriber activity.

In response to a positive determination at step 304, the SCP causes a notification message to be sent to the subscriber at step 308 indicating that the postpaid threshold has been reached. The notification message may comprise, for example, a short text message or recorded announcement (i.e., retrieved from announcement system 114) depending on the capabilities of the subscriber device. Thereafter, at step 310 (presuming the subscriber has set up a supplementary prepaid account), the SCP determines the sufficiency of the prepaid account balance to accommodate charges diverted from the postpaid account. If there is a sufficient balance, the SCP accrues charges to the prepaid account at step 312. It is contemplated that the prepaid charge rate will be less than the postpaid charge rate, such that the subscriber benefits by diverting charges to the prepaid account. In one embodiment, the prepaid charges accrue in real time until the activity is ended, determined at decision block 314. Until such time as the activity is ended, the SCP continues to monitor the prepaid balance at step 316.

If the SCP determines there is an insufficient balance in the prepaid account, the SCP causes a notification message to be sent to the subscriber at step 318 indicating that the prepaid account needs to be replenished (or “recharged”). The notification message may comprise, for example, a short text message or recorded announcement. Then, the SCP determines at decision block 320 whether overcharging (i.e., delivering services having a value greater than the prepaid balance) is permitted. If overcharging is not permitted, the SCP charges the postpaid account at step 322 at a postpaid charge rate (i.e., generally higher than the prepaid charge rate) thereby causing the subscriber to forego the benefit (or cease the benefit) of diverting charges to the prepaid account. If overcharging is permitted, the SCP accrues charges to the prepaid account at step 312 until the activity is ended, determined at decision block 314, or until charges accrue to a point that overcharging is no longer permitted. In one embodiment, when overcharging is no longer permitted, the SCP will accrue charges to the postpaid account (step not shown).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. In a communication system providing a service to a postpaid plan subscriber having a postpaid account, a method comprising:
monitoring subscriber activity relative to one or more postpaid plan thresholds, subscriber activity defining an amount of service provided to the subscriber within a billing period associated with the postpaid account;
for so long as the subscriber activity does not exceed a postpaid plan threshold, billing the subscriber activity according to the postpaid account; and
if the subscriber activity exceeds a postpaid plan threshold, defining surplus activity, billing at least a portion of the surplus activity to a supplementary account.

2. The method of claim 1, further comprising:
if the subscriber activity exceeds a postpaid plan threshold, defining surplus activity, sending a message to the subscriber including indicia of the subscriber activity exceeding the postpaid plan threshold.

3. The method of claim 1, wherein the supplementary account comprises a prepaid account, the step of billing to the supplementary account comprising billing at least a portion of the surplus activity to the prepaid account.

4. The method of claim 3, wherein the step of billing to the prepaid account comprises billing the surplus activity to the prepaid account at a lesser charge rate than would occur by billing the surplus activity to the postpaid account, the lesser charge rate defining a prepaid charge rate.

5. The method of claim 4, wherein the step of billing to the prepaid account comprises:
determining accumulated prepaid charges associated with the surplus activity;
monitoring the accumulated prepaid charges relative to an account balance associated with the prepaid account;
for so long as the accumulated prepaid charges do not exceed the account balance, billing the surplus activity to the prepaid account.

6. The method of claim 5, wherein the step of billing to the prepaid account further comprises:
upon the accumulated prepaid charges exceeding the account balance, defining overcharge activity, determining an eligibility of the prepaid account to accept overcharges; and
if the prepaid account is eligible to accept overcharges, billing the overcharge activity to the prepaid account.

7. The method of claim 6, further comprising:
upon the accumulated prepaid charges exceeding the account balance, defining overcharge activity, sending a message to the subscriber including indicia that the overcharge activity will be charged to the prepaid account.

8. The method of claim 6, further comprising, if the prepaid account is ineligible to accept overcharges:
determining postpaid charges associated with the overcharge activity, based on a postpaid charge rate; and
billing the postpaid charges to the postpaid account.

9. The method of claim 8, further comprising:
upon the accumulated prepaid charges exceeding the account balance, defining overcharge activity, sending a message to the subscriber including indicia that the overcharge activity will be charged to the postpaid account.

10. A method comprising:
establishing a prepaid account for contingency billing of a postpaid plan subscriber;
maintaining a record including indicia of activity of the postpaid plan subscriber relative to one or more postpaid plan thresholds; and
billing to the prepaid account in response to activity of the postpaid plan subscriber exceeding any of the one or more postpaid plan thresholds.
